(19) United States
(12) Patent Application Publication
(10) Pub. No.: US 2011/0214051 A1
(43) Pub. Date: Sep. 1, 2011

(54) METHODS AND APPARATUS TO SUBSCRIBE FOR CHANGE NOTIFICATIONS IN A DOCUMENT MANAGEMENT SYSTEM

(76) Inventors: Dejan Petronijevic, Mississauga (CA); Suresh Chitturi, Plano, TX (US)

(21) Appl. No.: 12/875,785

(22) Filed: Sep. 3, 2010

Related U.S. Application Data
(60) Provisional application No. 61/240,051, filed on Sep. 4, 2009.

(51) Int. Cl. G06F 17/21

(52) U.S. Cl. 715/255

(57) ABSTRACT

Methods and apparatus to subscribe for change notifications in a document management system are disclosed. An example method performed at a subscription proxy to notify a principal of a change to an extensible markup language (XML) document disclosed herein comprises extracting information from an XML document command protocol (XDCP) request received from an XML document management client (XDMC) used by the principal, mapping at least some of the information which was extracted to one or more corresponding parameters of a session initiation protocol (SIP) SUBSCRIBE request, and sending the SIP SUBSCRIBE request to an XML document management server (XDMS) to generate a subscription to notifications regarding changes to the XML document, the XML document being managed by the XDMS.

### RELATED APPLICATION

This patent claims priority from U.S. Provisional Application Ser. No. 61/240,051, entitled “Methods and Apparatus to Subscribe for Change Notifications in a Document Management System” and filed on Sep. 4, 2009. U.S. Provisional Application Ser. No. 61/240,051 is hereby incorporated by reference in its entirety.

### FIELD OF THE DISCLOSURE

The present disclosure relates generally to document management systems and, more particularly, to methods and apparatus to subscribe for change notifications in a document management system.

### BACKGROUND

Prior extensible markup language (XML) document management (XDM) systems include a subscription proxy employing session initiation protocol (SIP) messaging to allow XDM clients to subscribe to documents maintained by an XDM server and to receive from the XDM server notifications of changes to the subscribed documents. Accordingly, such prior XDM systems require each XDM client device to implement a SIP user agent (UA) to interface with the SIP-based subscription proxy. However, older and lower-end devices, and some other categories of devices, may not include a SIP UA or cannot otherwise be adapted to implement a SIP UA, thereby precluding such devices from processing SIP message exchanges. Therefore, such devices are unable to subscribe to changes to documents in prior XDM systems.

### BRIEF DESCRIPTION OF THE DRAWINGS

FIG. 1 depicts example user equipment clients interacting with a XML document management server to access a shared document.

FIG. 2 depicts an example network system in which the example user equipment clients and server of FIG. 1 can be implemented.

FIG. 3 depicts a first example XDM system capable of being implemented in the network system of FIG. 2 to enable the user equipment clients of FIGS. 1-2 to access shared information managed by the server of FIGS. 1-2.

FIG. 4 depicts an example logical storage structure that can be used to store shared documents in the systems of FIGS. 2-3 and 5-6.

FIG. 5 depicts a second example XDM system supporting subscription for document change notifications according to the techniques described herein.

FIG. 6 depicts a third example XDM system supporting subscription for document change notifications according to the techniques described herein.

FIG. 7 depicts an example subscription proxy supporting XML document command protocol (XDCP) messaging that may be used to implement subscription for document change notifications in the XDM systems of FIGS. 5-6.

FIG. 8 depicts an example message sequence diagram illustrating operation of the XDM systems of FIGS. 5-6 to support subscription for document change notifications.

FIG. 9 depicts a flowchart representative of an example process that may be performed to implement subscription functionality in the XDCP subscription proxy of FIG. 7.

FIG. 10 depicts a flowchart representative of an example process that may be performed to implement notification functionality in the XDCP subscription proxy of FIG. 7.

FIG. 11 is an example processor system that may execute example machine readable instructions to implement some or all of the processes of FIGS. 9-10 to implement the XDCP subscription proxy of FIG. 7.

### DETAILED DESCRIPTION

Although the following disclosure describes example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

Methods and apparatus to subscribe for change notifications in a document management system are disclosed herein. In contrast to the prior XDM systems described above, the methods and apparatus described herein support subscription to documents and receipt of associated notifications of document changes using non-SIP messaging. In an example implementation, the non-SIP messaging is implemented with XDCP messaging for subscription requests, and Open Mobile Alliance (OMA) Push Enabler for notifications. XDCP, which is an HTTP-based protocol, and OMA Push are based on protocols that, unlike SIP, can often be implemented in older and lower-end devices.

The non-SIP subscription and notification techniques described herein can be advantageous, at least under some circumstances, because they can provide functionality equivalent to existing SIP-based techniques without the need to support a SIP UA on the client. Furthermore, the non-SIP subscription and notification techniques described herein provide additional functionality not present in existing SIP-based techniques. For example, the non-SIP techniques described herein allow specification of a level of user interaction for processing notifications, and specification of a preferred notification type indicating what information is to be included in the notifications sent to XDM clients. Such specification of the level of user interaction and the preferred notification type is not available in conventional or existing XDM systems.

The example methods and apparatus described herein can be used in connection with mobile communication devices, mobile computing devices, or any other device capable of accessing information over a wired or wireless network. Such devices, also referred to as user equipment (UE), clients, or terminals, may include mobile smart phones (e.g., a BLACKBERRY® smart phone), personal digital assistants (PDA), laptop/notebook/netbook computers, desktop computers, set-top boxes, trusted network entities acting on behalf of the UE, etc.

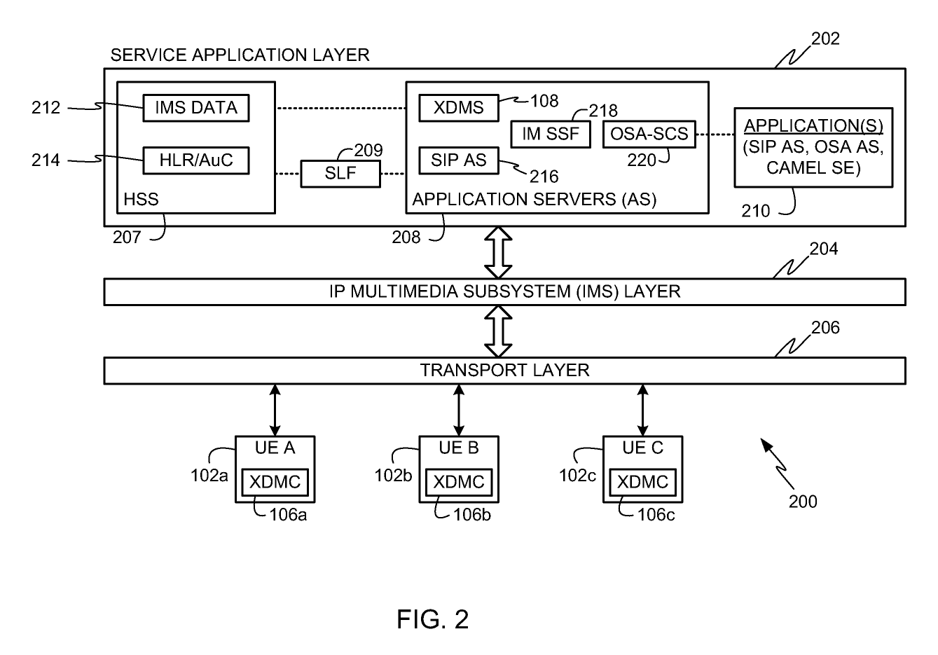

The example methods and apparatus are described herein in connection with the OMA standard related to XDM Enabler, which, among other things, defines how to access, modify, create, etc. information in XML documents stored on network storage entities. However, the example methods and apparatus may additionally or alternatively be implemented in connection with other information management and access standards and document format standards other than the XML format. In addition, although the example methods and apparatus described herein can be implemented in any network environment providing access to information stored on the network, the example methods and apparatus are described herein in connection with telecommunication network systems such as the network system 200 of FIG. 2 having an internet protocol (IP) multimedia subsystem (IMS).

The OMA XDM standard defines how to manipulate user-specific, service-related information stored in XML documents. Such information is often shared between different users or accessed from multiple devices of the same user, and is expected to be stored in the network where it can be located, accessed and manipulated (e.g. created, changed, and deleted) by those users. The XDM standard also defines how such information is to be defined in structured XML documents and defines a common protocol to access and manipulate such XML documents, by authorized principals (i.e., users with assigned access rights). Users access documents via XDM clients (XDMCs), such as UEs or other terminals, or other XDM or non-XDM servers acting as XDMCs. Access to the documents is managed in a network by one or more XDM servers (XDMSs) based on different access permissions uniquely corresponding to respective users.

The OMA XDM standard also specifies a search mechanism for locating XML documents of interest. Additionally, and as mentioned above, the OMA XDM standard defines SIP-based mechanisms by which XDMCs can subscribe to be notified when one or more XML documents of interest are changed.

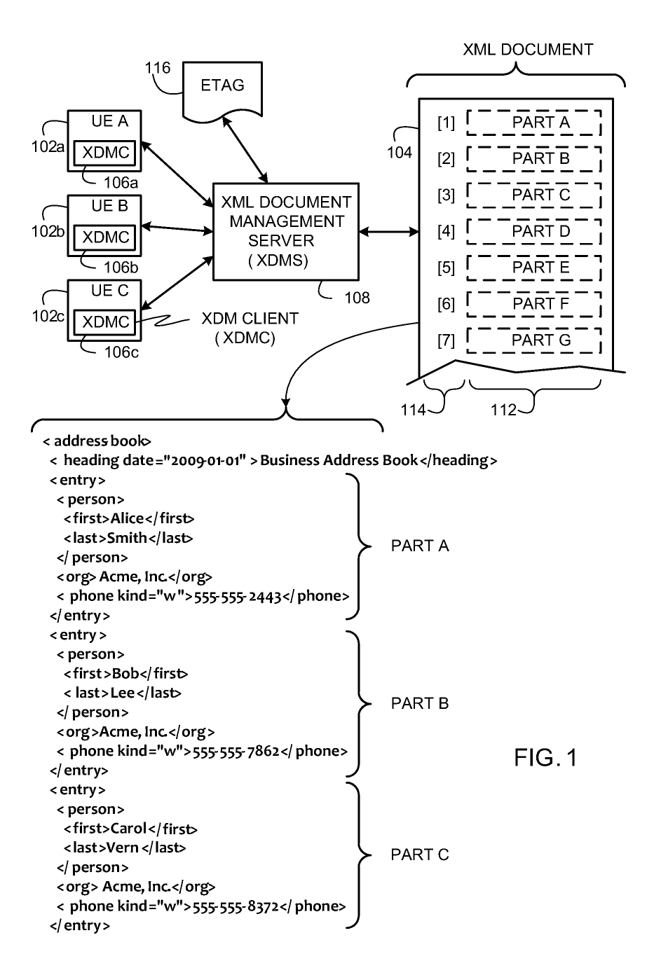

Turning to FIG. 1, example user equipment (UE) clients A-C 102a-c are shown requesting access to a shared document 104. In the illustrated example, each of the UE A-C clients 102a-c runs a respective XDMC 106a-c that communicates with an XDMS 108 to access the shared document 104. The shared document 104 is shown as an XML document. As described in greater detail below, the example methods and apparatus described herein can be implemented in an XDM system to allow the XDMCs 106a-c to subscribe to documents maintained by the XDMS 108 and receive from the XDMS 108 associated notifications of changes to the subscribed documents using non-SIP messaging.

Authorized XDM users are called principals, which include admin principals, primary principals, and regular principals. A primary principal is a user that owns a given document (e.g., the XML document 104) and has full access rights (e.g., read, write, delete). An admin principal is a user that is authorized to modify access permissions associated with a document and delegate rights to other principals. Documents have a primary principal and an admin principal that may be assigned, for example, at document creation time. In some instances, the primary principal and the admin principal can be the same user. A regular principal is a user that is assigned some access permissions associated with a document.

Additionally, the OMA XDM standard envisions scenarios in which multiple XDMCs 106a-c belonging to different principals may access the same XML document 104, potentially at the same time. To avoid potential collisions in which one of the XDMCs 106a-c blindly overwrites changes established by another of the XDMCs 106a-c, the OMA XDM standard specifies a versioning scheme involving entity tags (ETags). As shown in the example of FIG. 1, the XDMS 108 determines an ETag 116 associated with the XML document 104. The ETag 116 may contain a hash of the XML document 104 and a timestamp. Generally, the ETag 116 is generated by the XDMS 108 after each update of the XML document 104 based on a hash of the XML document 104 and a timestamp. A particular XDMC 106a-c is allowed to modify the XML document 104 only if it provides an ETag in its request to update the XML document 104 that matches the most recent ETag 116 of the XML document 104 maintained by the XDMS 108. If these ETags do not match, the request to update the XML document 104 fails and the requesting XDMC 106a-c receives the most recent ETag 116 in the associated error response from the XDMS 108.

Turning now to FIG. 2, the methods and apparatus described herein can be implemented in a communication network 200 implemented using an IP multimedia subsystem (IMS) as shown in FIG. 2. The example network 200 is shown as having a service application layer 202, an IMS layer 204, and a transport layer 206. In the illustrated example, the XDMS 108 of FIG. 1 implemented in the service application layer 202, and the XDMCs 106a-c communicate with the XDMS 108 via the transport layer 206. Although the methods and apparatus are described in connection with the network 200, the methods and apparatus can be implemented in any various networks

Turning in detail to the service application layer 202, in the illustrated example the service application layer 202 includes a home subscriber server (HSS) 207, a subscriber location function (SLF) 209, application servers 208, and one or more applications 210. The HSS 207 stores subscriber profiles (e.g., IMS data 212) and performs authentication and authorization processes (e.g., via a home location register/authentication center (HLR/AuC) 214) to determine communication services and features that users are authorized to access or use. The application servers 208 host and execute services and communicate with the IMS layer 204 using SIP. In the illustrated example, the application servers 208 include the XDMS 108, a SIP AS 216, an IP multimedia service switching function (IM SSF) 218, and an open service access-service capability server (OSA-SCS) 220.

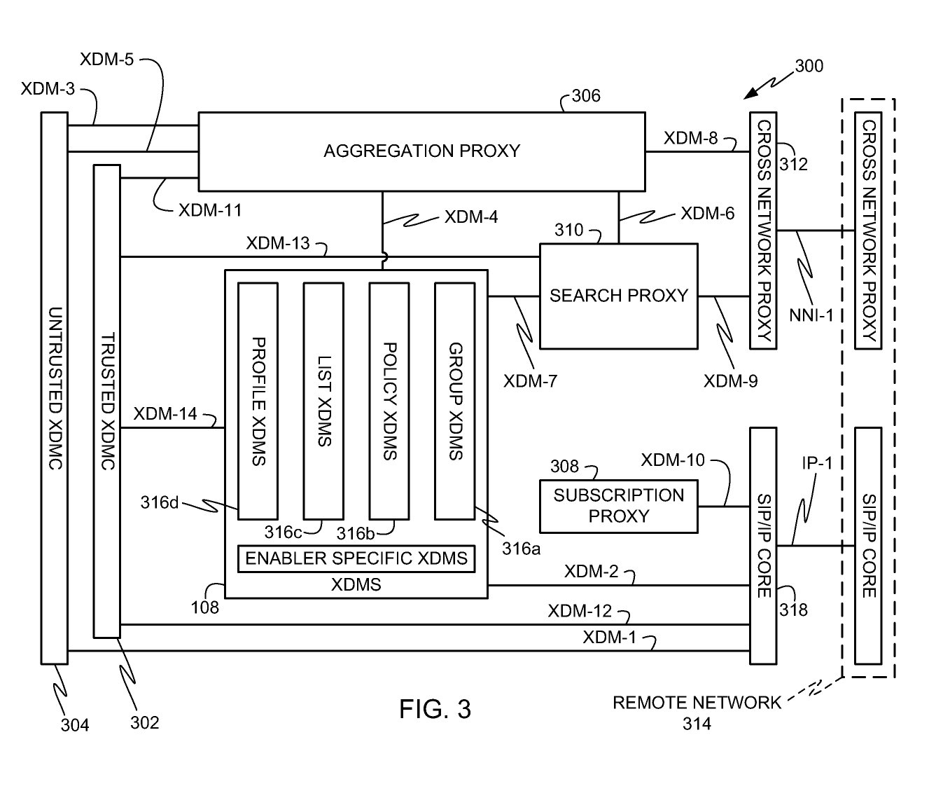

In the illustrated example, each of the XDMCs 106a-c initializes communications with the service application layer 202 through a SIP registration process that occurs via the IMS layer 204. After the SIP registration process, the XDMCs 106a-c can communicate with the XDMS 108 via the hypertext transfer protocol (HTTP) or, for example, the XML configuration access protocol (XCAP) based on HTTP, to perform document management functions. For example, the XDMCs 106a-c can submit information requests to and receive corresponding responses from the XDMS 108 using HTTP messages, and the requests and requested document information can be exchanged between the XDMCs 106a-c and the XDMS 108 via different proxies as described below in connection with FIG. 3.

FIG. 3 depicts an example XDM system 300 to enable the XDMCs 106a-c of FIG. 1 to access shared information (e.g., the XML document 104 of FIG. 1) stored in the network 200 of FIG. 2. The example XDM system 300 includes a plurality of different proxy interfaces (interfaces XDM-1 through XDM-14 as shown, which can also be referred to as reference points) that exchange communications with the XDMS 108 to provide the XDMCs 106a-c with access to shared information (e.g., the XML document 104 of FIG. 1). The interfaces XDM-1 through XDM-14 are described in greater detail below.

In the illustrated example, the XDM system 300 includes the XDMS 108 in communication with a trusted XDMC 302 and an untrusted XDMC 304. The trusted XDMC 302 or the untrusted XDMC 304 can be any of the XDMCs 106a-c of FIGS. 1-2, or an XDMC operating as part of the application(s) 210 of FIG. 2. For example, the trusted XDMC 302 could be an XDMC operating as part of the application(s) 210 and the untrusted XDMC 304 could be one of the XDMCs 106a-c. The methods and apparatus supporting subscription to XML document change notification described herein are usable with trusted and untrusted XDMCs alike. To enable communication with the XDMS 108, the XDM system 300 includes an aggregation proxy 306, a subscription proxy 308, a search proxy 310, and a cross-network proxy 312, all of which can be implemented using one or more different entities of the network 200 of FIG. 2. In the illustrated example, the aggregation proxy 306 performs authentication of XDMCs. In addition, the aggregation proxy 306 routes information requests to the appropriate XDMS 108 and routes search requests to the search proxy 310. Information requests can be made using XCAP requests as defined in IETF-RFC 4825. In the illustrated example, the aggregation proxy 306 is a single point of contact for untrusted XDMCs 304, and enables the untrusted XDMC 304 to make requests to and receive information from the XDMS 108.

The subscription proxy 308 is configured to provide notifications to XDMCs (e.g., the XDMCs 106a-c of FIGS. 1-2 and the XDMCs 302 and 304) of any changes to documents managed by the XDMS 108. For example, when a particular XDMC updates a document managed by the XDMS 108, all XDMCs subscribed to this document will be notified, including the particular XDMC performing the document update. The notification may or may not include a description of the change or an ETag (e.g., such as the ETag 116) corresponding to the updated document. Such notifications are generally sent without any guarantee of delivery and, thus, may be missed by XDMCs that are not actively operating in the XDM system 300. In addition, the subscription proxy 308 also maps XCAP resources to the SIP address of the XDMS 108 to enable proper routing of XCAP messages to the XDMS 108.

Generally, for an XDMC (e.g., the XDMCs 106a-c of FIGS. 1-2 and the XDMCs 302 and 304) to interface with the subscription proxy 308, a SIP User Agent (UA) must be implemented in the XDMC device. The subscription proxy 308 receives SIP SUBSCRIBE messages from one or more XDMCs (via respective one or more SIP UAs) requesting subscription to a document. By subscribing to a document, an XDMC will receive notifications when the document changes. Upon receiving the SIP SUBSCRIBE message(s) from the XDMC(s), the subscription proxy 308 subscribes for document changes with the particular XDMS 108 managing the document of interest. The subscription proxy 308 may subscribe to individual documents on behalf of multiple clients. The XDMS 108 notifies the subscription proxy 308 of a document change only once regardless of how many XDMCs are subscribed to the same document. The subscription proxy 308 is responsible for maintaining a list of interested XDMCs and notifying the individual XDMCs. The subscription proxy 308 subscribes to documents in the XDMS 108 and is notified about changes from the XDMS 108 using SIP SUBSCRIBE and NOTIFY messages, respectively. Alternatively, the XDMC may request subscription to documents in the XDMS 108 without the subscription proxy 308 and, instead, may subscribe directly to the XDMS 108 via the SIP/IP core 318. This latter mechanism is typically used for individual subscriptions that do not require an intermediate entity such as the subscription proxy 308 to aggregate subscriptions/notifications.

The search proxy 310 is provided to route and aggregate search requests and responses between XDMCs (e.g., the XDMCs 106a-c, 302, and 304), XDMSs (e.g., the XDMS 108), and the cross-network proxy 312. The cross-network proxy 312 enables XDM systems (similar to the XDM system 300) located in other networks (e.g., a remote network 314) to communicate over a trusted connection and exchange XCAP and search requests and responses with the XDM system 300.

In the illustrated example, the XDMS 108 is shown as a logical grouping or collection of a plurality of different XDMSs 316a-d in the XDM system 300. In particular, the XDMS 108 is shown in connection with a profile XDMS 316a, a list XDMS 316b, a policy XDMS 316c, and a group XDMS 316d, all of which are typical XDMSs in an XDM system. In addition, one or more additional enabler or application/service specific XDMSs may also be provided. Each of the XDMSs 316a-d provides XML document management services for its respective type of information. For example, the profile XDMS 316a manages and stores user profiles. The list XDMS 316b manages uniform resource identifier (URI) list and group usage list documents. The policy XDMS 316c manages user access policies. The group XDMS 316d manages group documents. In other example implementations, an XDM system may be provided with fewer or more types of XDMSs.

The XDMCs 302 and 304 communicate with the XDMS 108 via the interfaces XDM-1 through XDM-14 to access documents via the XDMS 108. The interfaces XDM-1, XDM-2, XDM-10, and XDM-12 enable SIP subscribe/notify exchanges between the XDMCs 302 and 304, a SIP/IP core 318, the XDMS 108, and the subscription proxy 308 to register the XDMCs 302 and 304 with the XDM system 300. The interfaces XDM-3 and XDM-4 enable exchanges associated with document management requests/responses and confirmations of access permissions. The interfaces XDM-5, XDM-6, XDM-7, and XDM-13 enable exchanges associated with search requests/responses. The interface XDM-8 enables forwarding of document management communications to other domains, and the interface XDM-9 enables forwarding of search requests/responses to other domains. The interfaces XDM-11 and XDM-14 enable communications associated with document management accesses (e.g., create, change, delete).

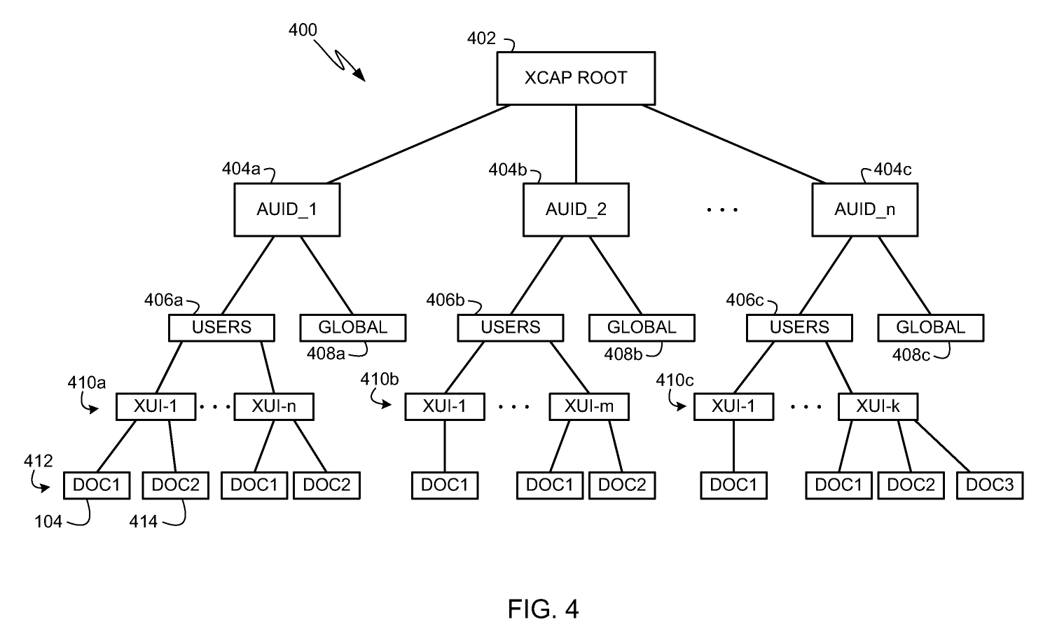

FIG. 4 depicts an example logical storage structure 400 of shared documents stored in the network 200 of FIG. 2. The XDMS 108 of FIGS. 1-3 can store documents based on the logical storage structure 400, and the documents can be associated with different application usages. For example, some documents may contain information associated with calendaring applications, while other documents may contain information associated with address books. Documents can also have other uses. For example, some uses can be application specific, while other uses are not application-specific. Example application-specific uses include storing subscriber preferences for particular service enablers (e.g., a presence subscription policy enabler or a push-to-talk over cellular (PoC) groups enabler). Example non-application-specific uses include storing a list of uniform resource identifiers (URIs) (e.g., a list of friends) that can be re-used from multiple enablers.

In some example implementations, the XDM standard can be used to implement a presence subscription policy to facilitate authorization of individuals who may wish to access another individual's presence information to determine whether that individual is presently available on a network for communication. In other example implementations, XDM can be used in a group calling application to specify a group definition to facilitate session initiation of many individuals to the same conference call. In these examples, there is common information that is shared across multiple OMA enablers. For example, a URI list defined within a presence subscription policy enabler could be used to initiate a conference call amongst an online group of friends.

As shown in FIG. 4, the logical storage structure 400 represents a flat tree hierarchy and includes an XCAP root path 402 under which application usage ID (AUID) trees 404a-c are located. The XCAP root path 402 is addressed by a standard URI. For example, a URI corresponding to the XCAP root path 402 could be http://example.com/address-book-xdm-server, with the XCAP root path 402 therefore corresponding to an application specific XDMS having a designation of example.com/address-book-xdm-server. As another example, a URI corresponding to the XCAP root path 402 could be http://example.com/Profile, with the XCAP root path 402 therefore corresponding to a profile XDMS, such as the profile XDMS 316a of FIG. 3.

An XDM server can manage documents corresponding to different application usages. Generally, each application usage has a corresponding XML schema or Document Type Definition (DTD) and defines characteristics, such as authorization policies, naming conventions, etc., for the documents associated with the particular application usage. Each application usage is identified by a unique AUID, which is typically a meaningful name, such as Profile, address-book etc. In the illustrated example, application usages reside within the XCAP root path 402 as the AUID trees 404a-c. Each of the AUID trees 404a-c is shown as having respective users trees 406a-c and global trees 408a-c. Each of the users trees 406a-c is shown as having specific user IDs (XUIs) 410a-c. Below each XUI are one or more documents 412. For example, the XML document 104 of FIG. 1 is shown as stored under the XUI-1 user ID tree.

In the illustrated example, each of the AUIDs 404a-c represents a different application usage, and each of the XUIs 410a-c represents a different user or principal under which documents store information pertinent to respective ones of the AUIDs 404a-c. For example, if the AUID 404a represents an address book application usage (i.e., AUID_1=‘address-book’), the XML document 104 can store contact information for a personal address book owned by the user XUI-1 410a, while another XML document 414 can store contact information for a business address book also owned by the user XUI-1 410a. When one of the XDMCs 106a-c requests access to any of the documents 412, an XCAP request is communicated to the XDMS 108 (FIGS. 1-3) with the request defining the path in the logical storage structure 400 indicating the document sought to be accessed. For example, a path ‘http://[XCAP Root]/address-book/users/someuser/buddies/˜˜/entry[5]’ indicates the fifth ‘entry’ element in the document named ‘buddies’ (e.g., personal address book) belonging to ‘someuser’ under the ‘address-book’ application usage.

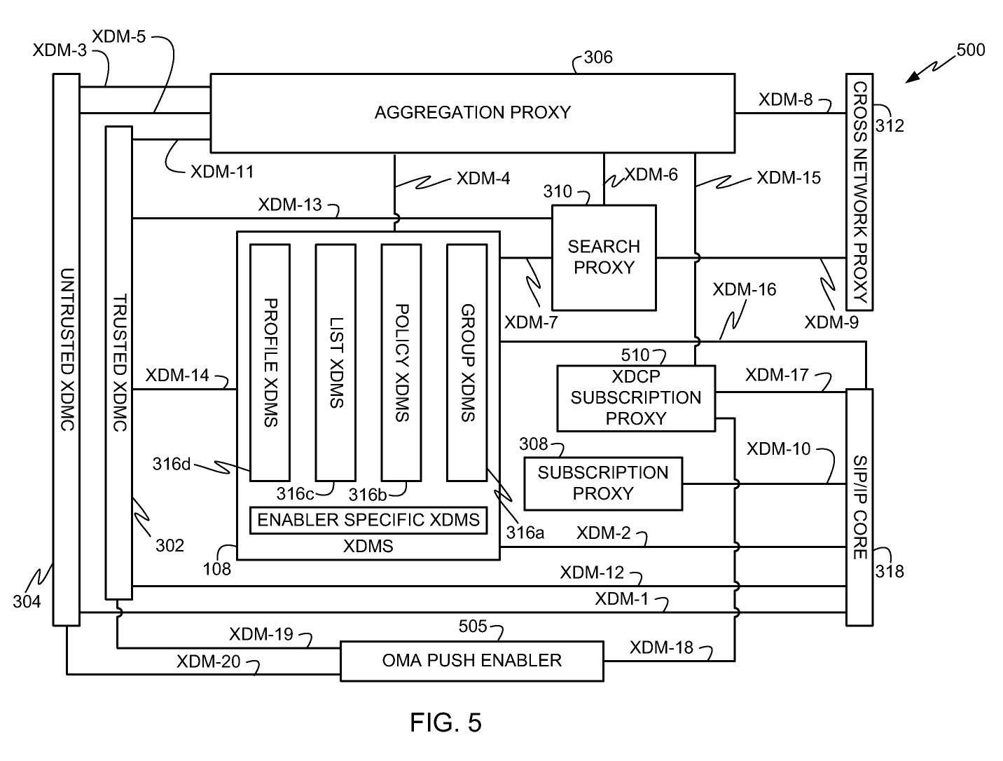

A first example XDM system 500 supporting subscription to documents and notification of changes according to the techniques described herein is illustrated in FIG. 5. As noted above, using the subscription proxy 308 to subscribe to documents in the XDMS 108 requires implementation of a SIP UA on each XDMC device. However, older and lower-end devices may not be able to process SIP message exchanges. Additional software may also need to be installed on a client device, which may be undesirable, to support interaction with the subscription proxy 308 via SIP. Therefore an alternate subscription mechanism that can be built upon resources already available on older and lower end devices is needed.

Existing approaches for supporting such non-SIP subscriptions in an XDM system typically require creation of a new XDMS or a new AUID, or both, to which a non-SIP XDMC can write subscription requests. The existing subscription proxy 308 is adapted to monitor the XML document where non-SIP XDMCs write their subscriptions. The subscription proxy 308 then performs backend subscriptions with the XDMS 108 for specific documents on behalf of the subscribing XDMCs using the existing SIP SUBSCRIBE and NOTIFY messaging scheme. The subscription proxy 308 in such existing approaches maintains the mapping between XDMCs subscribed for non-SIP notifications and subscribed XDMS documents.

Furthermore, document change notifications in these existing non-SIP solutions are sent using an OMA push enabler, such as the OMA push enabler 505 illustrated in the XDM system 500 of FIG. 5. For example, when the subscription proxy 308 receives a SIP notification from the XDMS 108, the subscription proxy 308 acts as a Push Initiator (PI) and sends a notification to the XDMC device through a Push Proxy Gateway (PPG) as defined under OMA push. An example of OMA push is described in OMA's “Push Architecture,” Candidate Version 2.2, OMA-AD-Push-V2_{—}2-20090609-C (Jun. 9, 2009). This notification sent by the subscription proxy 308 carries the document URI and a new ETag corresponding to the changed document. Upon receipt of the notification via the PPG, the subscribing XDMC can retrieve the entire changed document by issuing an XCAP GET command. Alternatively, if the XDMC supports incremental updates, it can request the cumulative changes between its previous ETag for the document and the ETag of the latest document on the server.

These existing approaches for supporting non-SIP subscriptions and notifications in an XDM system are inefficient and incomplete for numerous reasons. For example, the existing approaches require persistent storage of subscriptions in XDMS and its clean-up after processing, which is undesirable. Additionally, a client must perform a non-essential write in order to invoke a non-SIP subscription which is inconsistent with the SIP subscription mechanism already in place for XDM. Another disadvantage of the existing non-SIP approaches is that the XDMS and XDMC must implement the advanced incremental update feature in order to transfer only the change in the monitored document; otherwise the XDMC must retrieve the entire document every time there is a change. A further disadvantage is that many aspects of the subscribe/notify mechanism present in the SIP implementation are not supported in the existing non-SIP approaches. For example, features such as how to unsubscribe, subscription duration, and how to distinguish between multiple XDMCs on a single device are not provided in the existing non-SIP subscription and notification approaches.

In contrast, the techniques described herein for supporting non-SIP subscription to documents and receipt of associated non-SIP notifications of document changes do not suffer from the disadvantages of the existing non-SIP approaches. Instead, the non-SIP subscription and notification techniques described in the context of FIG. 5 and the subsequent figures can provide one or more advantages, at least under some circumstances, over the existing approaches. For example, these disclosed non-SIP subscription and notification techniques define a mechanism for an XDMC to subscribe for changes in XDM documents that provides much, if not all of, the functionality present in SIP SUBSCRIBE. These techniques also define non-SIP subscription parameters and their mapping to associated SIP SUBSCRIBE parameters that enable much, if not all, of the SIP-based subscription functionality to be achieved using non-SIP communications. Additionally, the disclosed techniques define a non-SIP mechanism for XDMC notifications and retrieval of changes in XDM documents that provides much, if not all, of the functionality present in SIP-based implementations. Furthermore, the disclosed techniques define the mapping of SIP NOTIFY message content to the content of non-SIP notifications.

Turning to FIG. 5, non-SIP subscription and notification functionality is implemented by an XDCP subscription proxy 510 operating in conjunction with the OMA push enabler 505 described above. In the illustrated example, the OMA push enabler 505 is implemented as a PPG 505, although the disclosed non-SIP subscription and notification techniques are not limited to such an implementation. At a high-level, the XDCP subscription proxy 510 operates to receive a non-SIP based XDCP subscription request from the trusted XDMC 302 or untrusted XDMC 304 via the aggregation proxy 306, requesting to subscribe to a document managed by the XDMS 108. The XDCP subscription proxy 510 maps the XDCP subscription request and the associated attributes to a corresponding SIP SUBSCRIBE message that can be sent to the XDMS to subscribe to the requested document on behalf of the XDMC 302 or 304. The XDCP subscription proxy 510 can then receive a SIP NOTIFY message from the XDMS 108 indicating a change to the subscribed document, and map the SIP NOTIFY message to the appropriate subscribing XDMC 302 or 304. The XDCP subscription proxy 510 then maps the contents of the SIP NOTIFY message to a corresponding push notification message that can be sent to the OMA push enabler 505. The OMA push enabler 505 then pushes the notification to the XDMC 302 or 304 using any appropriate push transport mechanism, which may include shorts messaging service (SMS), multimedia messaging service (MMS), wireless application protocol (WAP) PUSH, HTTP PUSH, among others.

Although the non-SIP subscription and notification functionality is described in the illustrated examples as being implemented primarily in the new XDCP subscription proxy 510, this functionality could be implemented alternatively by one or more other components of the XDM system 500. For example, the SIP-based subscription proxy 308 could be adapted to implement the non-SIP functionality described herein, including adding an interface to the subscription proxy 308 for receiving XDCP commands from the aggregation proxy 306. Alternatively, the aggregation proxy 306 could be adapted to implement non-SIP subscription and notification functionality, and could augment the SIP-based functionality provided by the existing subscription proxy 308. Alternatively, the non-SIP subscription and notification functionality could be distributed among an adapted subscription proxy 308, an adapted aggregation proxy 306, and/or other adapted components in the XDMS system 500.

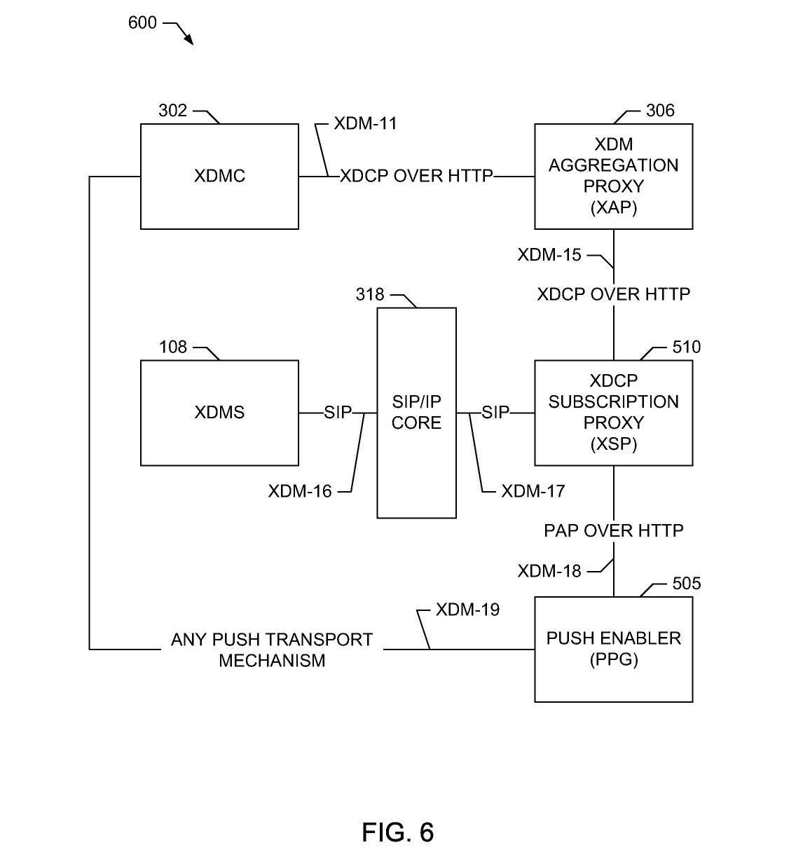

For convenience, FIG. 6 depicts a third example XDM system 600 illustrating those components of the XDM system 500 of FIG. 5 that are primarily responsible for implementing non-SIP subscription and notification as described herein. Turning to FIG. 6, the example XDM system 600 includes the XDCP subscription proxy 510 (also abbreviated as the XSP 510), the push enabler 505 (also referred to as the PPG 505), the aggregation proxy 306 (also abbreviated as the XAP 306), the XDMS 108 and the SIP/IP core 318. Also, by way of example, the XDMC 302 is depicted in the XDM system 600 of FIG. 6. However, any XDMC could be included in the XDM system 600, such as any or all of the XDMCs 106a-c, 302, and 304.

The XDM system 600 further includes interfaces XDM-11, XDM-15, XDM-16, XDM-17, XDM-18 and XDM-19. The XDM-11 interface supports the exchange of HTTP-based XDCP messages, in particular the XDCP SUBCRIBE commands as described herein between the XDMC 302 and the aggregation proxy 306. The XDM-15 interface supports the exchange of HTTP-based XDCP SUBCRIBE messages between the aggregation proxy 306 and the XDCP subscription proxy 510. XDCP is an HTTP-based protocol, and the particular XDCP SUBSCRIBE message disclosed herein is defined and described in greater detail below. The XDM-16 interface supports the exchange of SIP messages between the XDMS 108 and the SIP/IP core 318. The XDM-17 interface supports the exchange of SIP messages between the XDCP subscription proxy 510 and the SIP/IP core 318. The XDM-18 interface supports the exchange of OMA Push messages between the XDCP subscription proxy 510 and the push enabler 505 using the push access protocol (PAP). An example of PAP is described in OMA's “Push Access Protocol,” Candidate Version 2.2, OMA-TS-PAP-V2_{—}2-20090609-C (Jun. 9, 2009). The XDM-19 interface supports the exchange of push notifications between the push enabler 505 and the XDMC 302. The example non-SIP subscription and notification techniques described herein support any push transport mechanism implemented via the XDM-19 interface.

In an alternative implementation with the trusted XDMC 302 replaced with the untrusted XDMC 304, the XDM-11 interface is replaced with the XDM-3 interface, and the XDM-19 interface is replaced with the XDM-20 interface illustrated in FIG. 5.

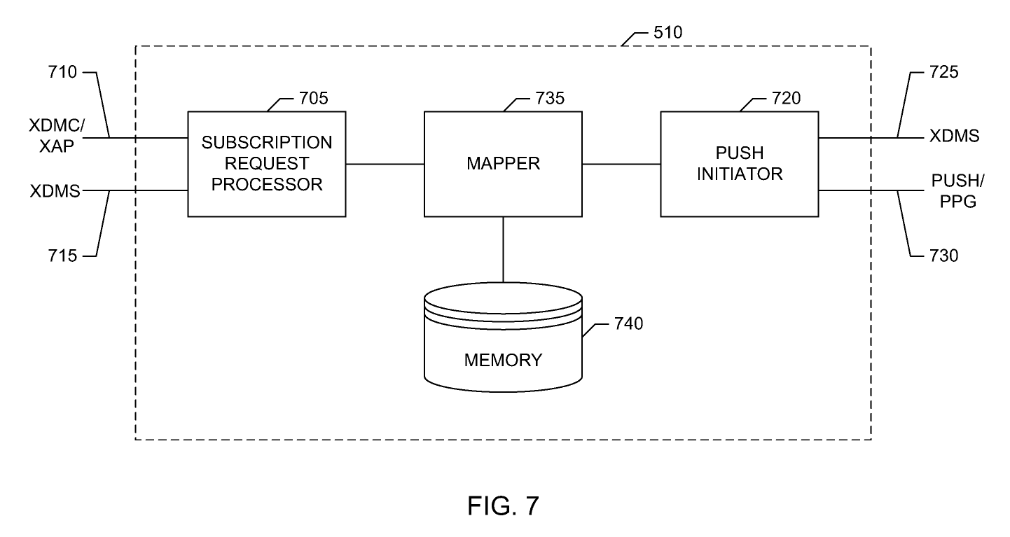

Before proceeding with a description of the XDM system of FIG. 6, an example implementation of the XDCP subscription proxy 510 is illustrated in FIG. 7. The XDCP subscription proxy 510 of FIG. 7 includes a subscription request processor 705 to receive and process XDCP subscription requests from, for example, the XDMC 302. As shown in FIG. 7, the XDCP subscription proxy 510 includes an XDCP interface 710 to communicatively couple the subscription request processor 705 with the XDM-15 interface to exchange XDCP messages with, for example, the XDMC 302 via the aggregation processor 306. The XDCP subscription proxy 510 of FIG. 7 also includes a SIP interface 715 to communicatively couple the subscription request processor 705 with the XDM-17 interface to exchange SIP messages with, for example, the XDMS 108 via the SIP/IP core 318.

The XDCP subscription proxy 510 of FIG. 7 also includes a push initiator 720 to receive and process notifications received from the XDMS 108 via the SIP/IP core 318 in response to subscription requests performed by the subscription request processor 705. As shown in FIG. 7, the XDCP subscription proxy 510 includes a SIP interface 725 to communicatively couple the push initiator 720 with the XDM-17 interface to exchange SIP messages with, for example, the XDMS 108 via the SIP/IP core 318. The XDCP subscription proxy 510 of FIG. 7 also includes an XDCP interface 730 to communicatively couple the push initiator 720 with the XDM-18 interface to exchange PAP messages with, for example, the push enabler 505.

The XDCP subscription proxy 510 of FIG. 7 further includes a mapper 735 to map the content of received XDCP subscribe messages to corresponding SIP SUBSCRIBE messages, and to map the content of resulting SIP NOTIFY messages to corresponding push notification messages. A memory 740 is included in the XDCP subscription proxy 510 of FIG. 7 to allow the mapper 735 to store its mapping information.

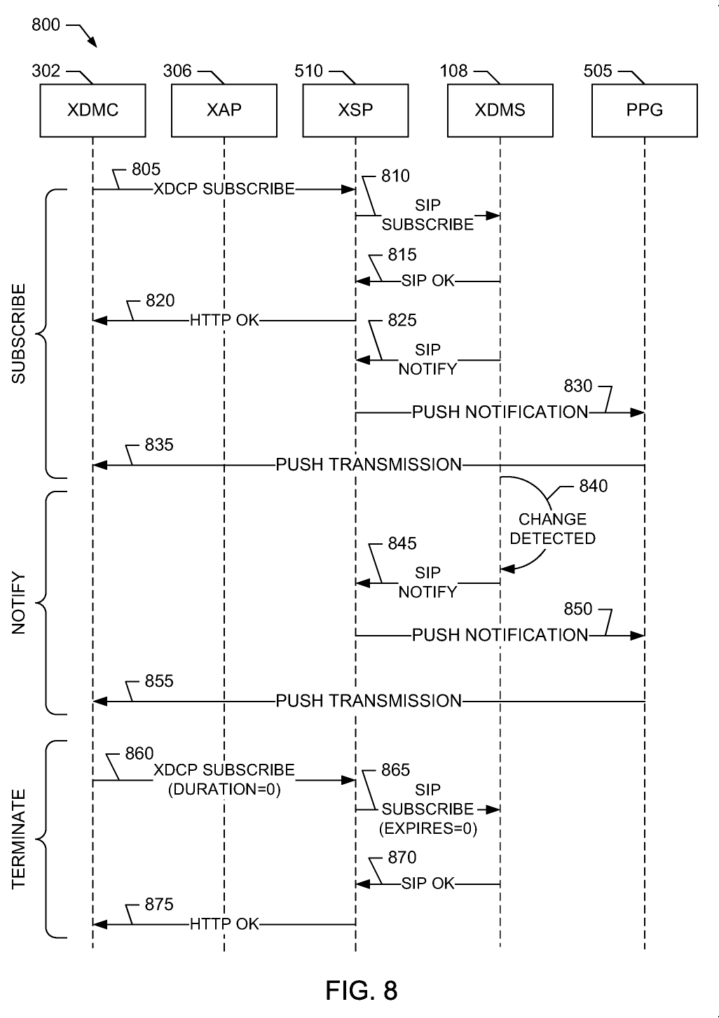

Operation of the XDM subscription proxy 510 of FIG. 7 in the XDM system 600 of FIG. 6 to support non-SIP document subscription and change notification is described in conjunction with the example message sequence diagram 800 illustrated in FIG. 8. The example message sequence diagram 800 depicts an efficient non-SIP mechanism for an XDMC to subscribe for changes in XDM documents that provides much, if not all, of the functionality present in SIP SUBSCRIBE. With reference to FIGS. 6-8, to subscribe for document changes, the XDMC 302 issues an XDCP SUBSCRIBE message 805 to the XDCP subscription proxy 510 via the aggregation proxy 306. The XDCP SUBSCRIBE message 805 is a new XDCP message introduced to support non-SIP document subscription and change notification as described herein. Similar to other XDCP commands, the XDCP SUBSCRIBE message 805 can be implemented in the form of one or more HTTP POST requests.

In the case when the XDMC 302 requests subscription for a single document, the HTTP POST request implementing the XDCP SUBSCRIBE message 805 includes a request URI identifying the document of interest. An example URI for a single document subscription is: http://[XCAPRoot]/org.openmobilealliance.xdcp/<auid>/users/<xui>/document. In this example URI, the component “[XCAPRoot]/org.openmobilealliance.xdcp” identifies the XDM system and indicates that the message is an XDCP command. Additionally, the component “/<auid>/users/<xui>/document” identifies the proper XDMS 108 and the document, node, or attribute within a node of interest to which subscription is being requested.

The body/payload of the HTTP POST request implementing the XDCP SUBSCRIBE message 805 carries the SUBSCRIBE command encoded in XML. The parameters and structure of the XDCP SUBSCRIBE message 805 and its mapping to corresponding SIP SUBSCRIBE parameters are described in the context of Table 1, which is described in greater detail below.

In the case when the XDMC 302 requests multiple subscriptions, in a single operation the request URI included in the HTTP POST request implementing the XDCP SUBSCRIBE message 805 does not identify any documents, nodes, or attributes of interest. Instead, the request URI is set to, for example, http://[XCAPRoot]/org.openmobilealliance.xdcp. A list of documents, nodes, or attributes to which the XDMC 302 is to subscribe is provided in the contents of the XDCP SUBSCRIBE message 805, as shown in Table 1. Accordingly, the XDM client 302 can make a single request for multiple subscriptions, thereby reducing the number of HTTP connections over-the-air/network leading to significant bandwidth reduction and performance improvements in the network and the XDM client respectively.

Next, the subscription request processor 705 in the XDCP subscription proxy 510 receives the XDCP SUBSCRIBE message 805 after the message is authenticated by the aggregation proxy 306. In the illustrated example, the XDCP subscription proxy 510 acts as a SIP Back To Back User Agent (B2BUA) using XDCP on the XDM-15 interface to the aggregations proxy and SIP on the XDM-17 interface towards the XDMS 108. In response to the received XDCP SUBSCRIBE message 805, the subscription request processor 705 in the XDCP subscription proxy 510 issues a SIP SUBSCRIBE message 810 to the XDMS 108 managing the requested document. If the SIP subscription initiated by the SIP SUBSCRIBE message 810 is successful and a SIP OK message 815 (e.g., such as a SIP 2xx message 815) is received from the XDMS 108 (as in the illustrated example), the mapper 735 in the XDCP subscription proxy 510 establishes a mapping between the XDMC 302 and the SIP subscription using the content from the XDCP SUBSCRIBE message 805. For example, the mapper 735 stores elements of the XDCP SUBSCRIBE message 805 necessary to process future notifications received for the SIP subscription and to route the notifications to the appropriate XDMC 302. After receiving the SIP OK message 815 and mapping the XDMC 302 to the SIP subscription resulting from the SIP SUBSCRIBE message 810, the subscription request processor 705 in the XDCP subscription proxy 510 sends an HTTP OK message 820 (e.g., such as an HTTP 2xx response 820) to the XDMC 302. If the XDMS 108 chose to reduce the duration of the subscription, the HTTP OK message 820 may carry reduced subscription duration information (e.g., extracted from a SIP “Expires” header included in the SIP OK message 815). If the SIP subscription is not successful (e.g., such as when the SIP OK message 815 is not received), the subscription request processor 705 in the XDCP subscription proxy 510 sends a failure code (e.g., such as an HTTP 4xx message not shown) to the XDMC 302, along with any reason provided by the XDMS 108.

Although not illustrated in the message sequence diagram 800 of FIG. 8, instead of receiving the SIP OK message 815, the XDCP subscription proxy 510 may receive a SIP forwarding message (e.g., such as a SIP 3xx message) from the XDMS 108. The SIP forwarding message identifies a different XDMS now responsible for managing the document of interest. In such a scenario, the subscription request processor 705 in the XDCP subscription proxy 510 may retry subscribing to the document of interest using an address provided in the SIP forwarding message for the identified XDMS.

To complete the subscription process, the XDMS 108 sends an initial SIP NOTIFY message 825 that is received by the push initiator 720 in the XDCP subscription proxy 510. The initial SIP NOTIFY message 825 is not used to indicate that a change to the subscribed document has occurred but, instead, is used to provide, for example, the ETag associated with the current version of the document. In response to receiving the initial SIP NOTIFY message 825, the push initiator 720 in the XDCP subscription proxy 510 generates a PUSH NOTIFICATION message 830 from the contents of the SIP NOTIFY message 825 and sends the PUSH NOTIFICATION message 830 to the push enabler 505. The push enabler 505 then pushes the content of the PUSH NOTIFICATION message 830 to the XDMC 302 using any appropriate push transmission mechanism 835. The structure and contents of the PUSH NOTIFICATION message 830 are described in greater detail below in the context of notification processing.

Table 1 illustrates data elements that can be included in an example XDCP SUBSCRIBE message 805. These data elements, along with the mapping of these data elements to associated SIP SUBSCRIBE parameters described below, enable full SIP-based subscription functionality to be achieved using non-SIP messaging. In an example implementation, the following data elements represent a subset that may be included in the XDCP SUBSCRIBE message 805: tel-uri, wap-application-id, user-interaction-level and preferred-notification-type.

TABLE 1

| XDCP | |
|---|---|
| SUB- | |
| SCRIBE | |
| DATA | |
| ELE- | |
| MENT | DESCRIPTION |
| tel-uri | Identifies the non-SIP subscribing device's identity or URI to |
| | which the notifications are to be sent if the “X-XCAP-Asserted- |
| | Identity” header of the HTTP POST request does not contain |
| | that information. |
| duration | Specifies the duration of the subscription in seconds and maps to |
| | the SIP Expires header |
| wap- | An Open Mobile Alliance Naming Authority (OMNA) |
| appli- | registered application identifier (ID) specifying which one of the |
| cation- | possibly multiple XDMCs on a particular device is subscribing |
| id | for changes of the document. This data element is used for |
| | proper routing of notifications to the appropriate XDMC |
| | application on the device. |
| user- | Indicates a level of user interaction for processing notifications. |
| inter- | If the value is set to “none”, the affected document(s) will be |
| action- | updated to reflect the notified document changes quietly in the |
| level | background without user interaction. If the value is set to “low”, |
| | “medium” or “high” the user will be prompted with various |
| | degrees of urgency. The values of this element correspond to |
| | the values of the “action” attribute of the “indication” element of |
| | the “Service Indication” type of the push message. |
| preferred- | Indicates whether the XDMC prefers the document changes |
| notifi- | (e.g., in the form of the xcap-diff mime type) to be included in |
| cation- | the notification (corresponding to a value set to “push”), or |
| type | stored on the server with only a URL pointing to changes to be |
| | included in the notification (corresponding to a value set to |
| | “pull”), or having the notification include just the XCAP URL of |
| | the changed document (corresponding to a value set to “none”). |
| target- | When subscribing for multiple documents (or elements/ |
| document | attributes within the document) this element contains the |
| | XCAP address of the document/element/attribute in the |
| | following format: <auid>/users/<xui>/document. |
| | This element may be repeated multiple times in a sequence. |

As described above, the XDCP subscription proxy 510 generates the SIP SUBSCRIBE message 805 and sends it to the XDMS 108 managing the document of interest. In an example implementation, the mapper 735 in the XDCP subscription proxy 510 maps the element “duration” in the XDCP SUBSCRIBE message 805 to the SIP header “Expires” of the SIP SUBSCRIBE message 810. Additionally, the mapper 735 maps the “X-XCAP-Asserted-Identity” header from the HTTP POST request implementing the XDCP SUBSCRIBE message 805 to the “P-Asserted-Identity” SIP header of the SIP SUBSCRIBE message 810. In case of single document subscription, the mapper 735 also maps the “/<auid>/users/<xui>/document” part of the request URL to the “Content-Type application/resource-lists+xml” portion of the SIP SUBSCRIBE message 810. In the case of multiple document subscription, the mapper 735 maps parameters from the “target-document” data element of the XDCP SUBSCRIBE message 805 to the “Content-Type application/resource-lists+xml” portion of the SIP SUBSCRIBE message 810. Furthermore, the mapper 735 sets the “From”, “To” and “Contact” SIP headers of the SIP SUBSCRIBE message 810 to the tel-uri of the requesting device, as provided in the XDCP SUBSCRIBE message 805. Also, the mapper 735 sets the domain name to the domain or IP address of the XDCP subscription proxy 510.

Returning to FIG. 8, and with reference to FIGS. 6-7, the message sequence diagram 800 also depicts an efficient non-SIP mechanism for XDMC notifications and retrieval of changes in XDM documents that provides much, if not all, of the functionality present in SIP-based implementations. In particular, after successful completion of the subscription process, the XDMS 108 monitors for changes to the subscribed document. When a change to the monitored document is detected (represented by the directed line 840 in FIG. 8), the XDMS 108 sends a SIP NOTIFY message 845 that is received by the push initiator 720 in the XDCP subscription proxy 510. Upon reception of the SIP NOTIFY message 845, the push initiator 720 in the XDCP subscription proxy 510 assembles a PUSH NOTIFICATION message 850 based on information contained in the SIP NOTIFY message 845 and associated subscription information that was extracted from the XDCP SUBSCRIBE message 805 by the mapper 735 during the subscription process, as described above. The push initiator 720 in the XDCP subscription proxy 510 then submits the PUSH NOTIFICATION message 850 to the push enabler 505 using, for example, PAP as described in OMA's aforementioned “Push Access Protocol” document. Using any appropriate push transmission mechanism 855, push enabler 505 then pushes the content of the PUSH NOTIFICATION message 850 to the XDMC 302.

In an example implementation of mapping SIP NOTIFY message content to the content of the non-SIP PUSH NOTIFICATION message 850, the push initiator 720 in the XDCP subscription proxy 510 performs any, some or all of the following operations to assemble the PUSH NOTIFICATION message 850 using an OMA Push Message, although not necessarily in the order in which the operations are described. An example OMA Push Message is described in OMA's “Push Message”, Candidate Version 2.2, OMA-TS-Push Message-V2_{—}2-20090609-C (Jun. 9, 2009). First, the push initiator 720 sets the X-Wap-Application-Id header of the OMA Push Message to the “wap-application-id” provided in the XDCP SUBSCRIBE message 805. Then, the push initiator 720 sets the type of the OMA Push Message to “Service Indication.”

Next, the push initiator 720 sets the “action” attribute of the “indication” element of the “Service Indication” OMA Push Message to the value supplied in the “user-interaction-level” of the XDCP SUBSCRIBE message 805. The user-interaction-level element of the XDCP SUBSCRIBE message 805 allows specification of various user interaction levels for involving the XDMC 302 in the updating of a subscribed document upon notification of change. This ability to specify user interaction levels can provide an advantage over existing SIP and non-SIP subscription and notification techniques. The user-interaction-level in the XDCP SUBSCRIBE message 805 can be governed by user preferences, service provider policies, etc.

In an example implementation, the user-interaction-level can take on values of “none,” “low”, “medium” and “high.” In such an example, a user-interaction-level of none indicates that no user interaction is employed or otherwise specified, and a changed document can be updated on the affected XDMC device without involving the user. In contrast, a user-interaction-level of low, medium or high employs or specifies some user interaction (e.g., such as an approval) before any document updating can take place. The different levels of low, medium and high can be used to configure the XDMC device to prompt the user using different techniques and/or different levels of urgency.

Another operation performed by the push initiator 720 to assemble the PUSH NOTIFICATION message 850 is to determine what to include in the body of the OMA Push Message based on the “preferred-notification-type” set in the XDCP SUBSCRIBE message 805. This ability to specify preferred notification types can also provide an advantage over existing SIP and non-SIP subscription and notification techniques. In an example implementation, the XCAP URL of the changed document is mapped to the “href” attribute of the “indication” element of the “Service Indication” OMA Push Message implementing the PUSH NOTIFICATION message 850. Additionally, a new ETag of the document is supplied as the content of the “indication” element in the following format: new-etag=“123xyz”. Furthermore, if “push” is specified as the preferred-notification-type in the XDCP SUBSCRIBE message 805, the changes contained in the xcap-diff XML document (being a document different/distinct from the changed document and which contains a listing, enumeration or the like of the changes (i.e., diffs) that were made to the XML document to arrive at the changed document), which is supplied in the body of the SIP NOTIFY message 810, are included in the body of the OMA Push Message implementing the PUSH NOTIFICATION message 850 (e.g., by being included as the “item” element of the “info” element of the “Service Indication” OMA Push Message, with the “class” attribute of the “item” element set to the value “xcap-diff”). If “pull” is specified, the changes contained in the xcap-diff XML document, which is supplied in the body of the SIP NOTIFY message 810, are stored in a (new) Application Usage under the global tree, and the XCAP URL for that document (i.e., an XDM document containing the changes from the xcap-diff document) is included in the body of the OMA Push Message implementing the PUSH NOTIFICATION message 850 (e.g., by being included as the “item” element of the “info” element of the “Service Indication” OMA Push Message, with the “class” attribute of the “item” element set to the value “xcap-url”) such that the XDMC can obtain the document changes by a subsequent pull operation or request message. If “none” is specified, only the new ETag and XCAP URL of the changed document are included in the body of the OMA Push Message implementing the PUSH NOTIFICATION message 850.

Returning to FIG. 8, and with reference to FIGS. 6-7, in order to terminate the existing subscription, the XDMC 302 issues an XDCP SUBSCRIBE message 860 having a duration of 0. Upon receipt via the aggregation proxy 306, the subscription request processor 705 in the XDCP subscription proxy 510 sends a SIP SUBSCRIBE message 865 having a corresponding expires field of 0 to the XDMS 108. In response, the XDMS 108 returns a SIP OK message 870 that is received by subscription request processor 705 in the XDCP subscription proxy 510, which in turn sends an HTTP OK message 875 to the XDMC 302, thereby indicating the subscription has been terminated successfully.

In another example scenario, the XDMS 108 may terminate the subscription at any time by issuing a SIP NOTIFY request (not shown) with a subscription-state header set to “terminated.” The XDCP subscription proxy 510 then notifies the XDMC 302 about the failure using the push notification procedures described above.

While an example manner of implementing the XDCP subscription proxy 510 of FIGS. 5 and 6 has been illustrated in FIG. 7 and described in the context of FIG. 8, one or more of the elements, processes and/or devices illustrated in FIG. 7 may be combined, divided, re-arranged, omitted, eliminated and/or implemented in any other way. Further, the subscription request processor 705, the push initiator 720, the mapper 735, the memory 740 and/or, more generally, the XDCP subscription proxy 510 of FIG. 7 may be implemented by hardware, software, firmware and/or any combination of hardware, software and/or firmware. Thus, for example, any of the subscription request processor 705, the push initiator 720, the mapper 735, the memory 740 and/or, more generally, the XDCP subscription proxy 510 could be implemented by one or more circuit(s), programmable processor(s) executing software or firmware instructions, application specific integrated circuit(s) (ASIC(s)), programmable logic device(s) (PLD(s)) and/or field programmable logic device(s) (FPLD(s)), etc. In some instances, at least one of the XDCP subscription proxy 510, the subscription request processor 705, the push initiator 720, the mapper 735 and/or the memory 740 is hereby expressly defined to include a tangible medium such as a memory, digital versatile disk (DVD), compact disk (CD), etc., storing such software and/or firmware. Further still, the XDCP subscription proxy 510 of FIG. 7 may include one or more elements, processes and/or devices in addition to, or instead of, those illustrated in FIG. 7, and/or may include more than one of any or all of the illustrated elements, processes and devices.

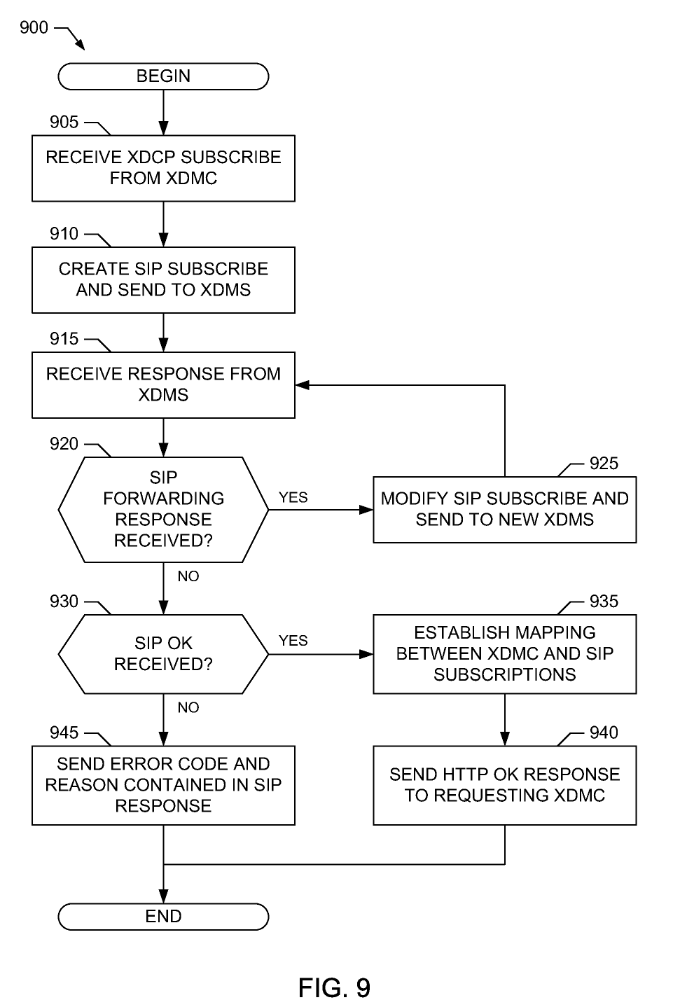

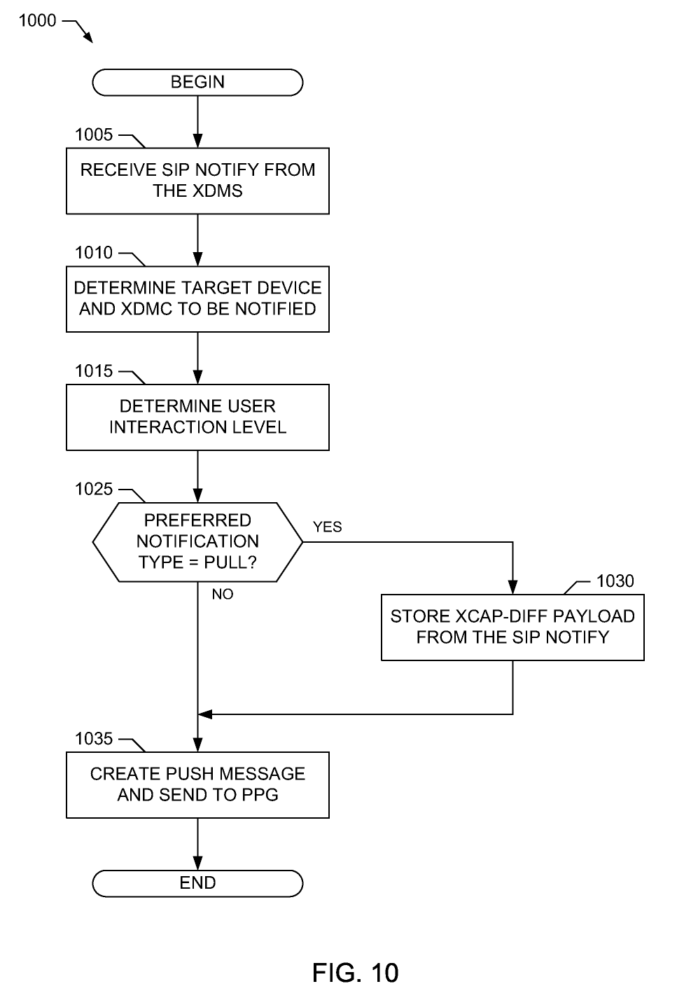

Flowcharts representative of example processes that may be executed to implement any, some or all of the XDM systems 500 and 600, the XDCP subscription proxy 510, the subscription request processor 705, the push initiator 720, the mapper 735 and the memory 740 are shown in FIGS. 9-10.

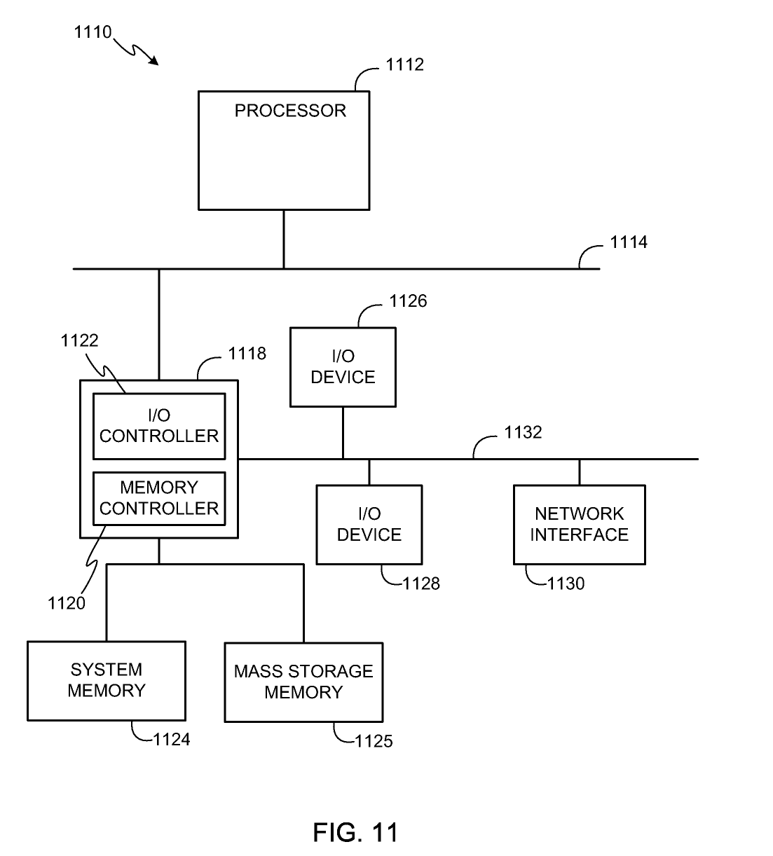

In these examples, the processes represented by the flowcharts may be implemented by one or more programs comprising machine readable instructions for execution by: (a) a processor, such as the processor 1112 shown in the example processing system 1110 discussed below in connection with FIG. 11, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1112, but the entire program or programs and/or portions thereof could alternatively be executed by a device other than the processor 1112 and/or embodied in firmware or dedicated hardware (e.g., implemented by an application specific integrated circuit (ASIC), a programmable logic device (PLD), a field programmable logic device (FPLD), discrete logic, etc.). For example, any one, some or all of the XDM systems 500 and 600, the XDCP subscription proxy 510, the subscription request processor 705, the push initiator 720, the mapper 735 and the memory 740 could be implemented by any combination of software, hardware, and/or firmware. Also, some or all of the process represented by the flowcharts of FIGS. 9-10 may be implemented manually.

Further, although the example processes are described with reference to the flowcharts illustrated in FIGS. 9-10, many other techniques for implementing the example methods and apparatus described herein may alternatively be used. For example, with reference to the flowcharts illustrated in FIGS. 9-10, the order of execution of the blocks may be changed, and/or some of the blocks described may be changed, eliminated, combined and/or subdivided into multiple blocks.

An example process 900 that may be executed to implement non-SIP document subscription functionality in the XDCP subscription proxy 510 of FIGS. 5-7 is illustrated in FIG. 9. The example process 900 may be executed as a background process, based on an occurrence of a predetermined event (e.g., such as being triggered upon receipt of the XDCP SUBSCRIBE message 805), etc., or any combination thereof. With reference to the XDCP subscription proxy 510 of FIG. 7 and the message sequence diagram 800 of FIG. 8, the non-SIP subscription process 900 of FIG. 9 begins execution at block 905 at which the subscription request processor 705 in the XDCP subscription proxy 510 receives the XDCP SUBSCRIBE message 805 from the XDMC 302. As discussed above, the XDCP SUBSCRIBE message 805 is a non-SIP message sent by the XDMC 302 to subscribe for changes to one or more documents managed by the XDMS 108.

Next, control proceeds to block 910 at which the subscription request processor 705, in conjunction with the mapper 735 in the XDCP subscription proxy 510, uses the contents of the received XDCP SUBSCRIBE message 805 as described above to create the corresponding SIP SUBSCRIBE message 810. After creating the SIP SUBSCRIBE message 810, the subscription request processor 705 sends it to the XDMS 108.

Control then proceeds to block 915 at which the subscription request processor 705 in the XDCP subscription proxy 510 receives a response from the XDMS 108. If the response is a SIP forwarding message (block 920), control proceeds to block 925 at which the subscription request processor 705 modifies the SIP SUBSCRIBE message 810 to include the address of the new (e.g., forwarding) XDMS identified in the received SIP forwarding message. The subscription request processor 705 then sends the modified SIP SUBSCRIBE message 810 to the new (e.g., forwarding) XDMS. Control then returns to block 915 and blocks subsequent thereto at which the XDCP subscription proxy 510 waits for and receives a response from the new (e.g., forwarding) XDMS.

However, if the response is not a SIP forwarding response (block 920), the subscription request processor 705 in the XDCP subscription proxy 510 determines whether the SIP OK message 815 was received (block 930). If the SIP OK message 815 was received (block 930), control proceeds to block 935 at which the mapper 735 in the XDCP subscription proxy 510 establishes parameters needed to map the XDMC 302 with the subscription invoked with the XDMS 108, as described above. Control then proceeds to block 940 at which the subscription request processor 705 sends the HTTP OK message 820 to the XDMC 302 from which the XDCP SUBSCRIBE message 805 was received at block 905. Execution of the example non-SIP subscription process 900 then ends.

If, however, the SIP OK message 815 was not received (block 930), control proceeds to block 945. At block 945, the subscription request processor 705 in the XDCP subscription proxy 510 sends a failure code (e.g., such as an HTTP 4xx message) to the XDMC 302 from which the XDCP SUBSCRIBE message 805 was received at block 905. The sent failure code can also include any reason provided by the XDMS 108 in the SIP response that was received at block 915. Execution of the example non-SIP subscription process 900 then ends.

An example process 1000 that may be executed to implement non-SIP change notification functionality in the XDCP subscription proxy 510 of FIGS. 5-7 is illustrated in FIG. 10. The example process 1000 may be executed as a background process, based on an occurrence of a predetermined event (e.g., such as being triggered upon receipt of the SIP NOTIFY message 845), etc., or any combination thereof. With reference to the XDCP subscription proxy 510 of FIG. 7 and the message sequence diagram 800 of FIG. 8, the non-SIP notification process 1000 of FIG. 10 begins execution at block 1005 at which the push initiator 720 in the XDCP subscription proxy 510 receives the SIP NOTIFY message 845 indicating that a change to a monitored document has occurred.

Next, control proceeds to block 1010 at which the push initiator 720, in conjunction with the mapper 735 in the XDCP subscription proxy 510, begins assembling the PUSH NOTIFICATION message 850 by determining that the XDMC 302 and its associated target device are to be notified of the document change reported by the received SIP NOTIFY message 845. For example, at block 1010 the XDMC 302 and associated target device can be identified based on information contained in the SIP NOTIFY message 845 and associated subscription information that was extracted from the XDCP SUBSCRIBE message 805 by the mapper 735 during the subscription process as described above.

Control then proceeds to block 1015 at which the push initiator 720, in conjunction with the mapper 735, determines the user-interaction-level to be set in the PUSH NOTIFICATION message 850. For example, the user-interaction-level can be determined at block 1015 based on information extracted from the XDCP SUBSCRIBE message 805 by the mapper 735 during the subscription process as described above.

Next control proceeds to block 1025 at which the push initiator 720, in conjunction with the mapper 735, begins configuring the preferred-notification-type in the PUSH NOTIFICATION message 850. For example, the preferred-notification-type can be determined based on information extracted from the XDCP SUBSCRIBE message 805 by the mapper 735 during the subscription process as described above. If the preferred-notification-type is “pull” (block 1025), control proceeds to block 1030 at which the push initiator 720 stores the xcap-diff XML document supplied in the body of the SIP NOTIFY message 810 received at block 1005 in the memory 740 for subsequent retrieval by the XDMC 302. Then, after processing at block 1030 completes, or if the preferred-notification-type is not “pull” (block 1025), control proceeds to block 1035.

At block 1035, the push initiator 720 in the XDCP subscription proxy 510 completes generation of the PUSH NOTIFICATION message 850 and sends it to the push enabler 505 for subsequent transmission to the XDMC 302. Execution of the example non-SIP notification process 1000 then ends.

As yet another example, the non-SIP document subscription and change notification techniques described herein can be implemented in an OMA-compliant XDM system by appropriately modifying OMA's “XML Document Management (XDM) Specification,” Candidate Version 2.0, OMA-TS-XDM Core-V2_{—}0-20080916-C (Sep. 16, 2008). An example modification to OMA's “XML Document Management (XDM) Specification” to support the non-SIP document subscription and change notification techniques described herein is to include the following text, beginning with the BEGIN label and ending with the END label.

BEGIN

To subscribe to be notified of changes in XDM documents, XDMC SHALL send the “SUBSCRIBE” XDCP command. The SUBSCRIBE command is encoded in XML.

In the case when subscription is for a single document the request URI indicates the document of interest as follows:

http://[XCAPRoot]/org.openmobilealliance.xdcp/<auid>/users/<xui>/document
where “[XCAPRoot]/org.openmobilealliance.xdcp” identifies the XDM system and that it is an XDCP command, and “/<auid>/users/<xui>/document” determines the proper XDMS and the document. When an XDMC subscribes for multiple documents the request URI does not specify the document as follows:
http://[XCAPRoot]/org.openmobilealliance.xdcp
In the case of multiple document subscription, the list of documents to subscribe to SHALL be provided in the body of the SUBSCRIBE command.

The SUBSCRIBE command SHALL contain the following information:

1) The tel-URI of the subscribing non-SIP device identity to which the notifications are to be sent if the “X-XCAP-Asserted-Identity” header of the HTTP POST request does not contain that information.
2) The duration of the subscription in seconds.
3) The OMNA registered application ID specifying which of the possibly multiple XDMCs on the device is subscribing for changes of the document.
4) The indication of level of user interaction is required for processing notifications. Values of “none”, “low”, “medium” or “high” are allowed.
5) The indication whether the document changes need to be (i) included in the notification, or (ii) stored on the server with only the URL pointing to changes to be included in the notification, or (iii) no changes need to be included and only the XCAP URL of the changed document is to be included in the notification.

After receiving the XDCP SUBSCRIBE command, the XDCP Subscription Proxy SHALL issue a SIP SUBSCRIBE command to the XDMS managing the requested document. If the SIP subscription is successful, the XDCP Subscription Proxy establishes mapping between the XDMC and the SIP subscription and stores elements of the XDCP SUBSCRIBE command necessary for future notifications together with the mapping (as listed above). That information will be used for future notifications of changes.

Upon reception of the SIP NOTIFY message the XDCP Subscription Proxy assembles a push message notification based on the information contained in the SIP NOTIFY message and associated subscription mapping. Acting as a Push Initiator, the XDCP Subscription Proxy SHALL submit the push message to the Push Proxy Gateway (PPG) using Push Access Protocol (PAP).

While assembling the push message the (XDCP) Subscription Proxy SHALL include the following information:

1. Set the X-Wap-Application-Id header to “wap-application-id” provided with the subscription.
2. Set the type of the push message to “Service Indication”
3. Set the “action” attribute of the “indication” element of the “Service Indication” push message to the value supplied in the “user-interaction-level” provided with the subscription.
4. Based on the “preferred-notification-type” element, determine what to include in the body of the push message. If “push” is specified, the entire xcap-diff XML document supplied in the body of the original SIP NOTIFY message SHALL be included in the push message body. If “pull” is specified, the xcap-diff XML document supplied in the body of the original SIP NOTIFY message SHALL be stored in the XCAP-DIFF Application Usage under the global tree. The XCAP URL for that document SHALL be included in the body of the push message. If “none” is specified, only the new ETag and XCAP URL of the changed document SHALL be included in the body of the push message.

END

FIG. 11 is a block diagram of an example processor system 1110 that may be used to implement the example methods and apparatus described herein. For example, processor systems substantially similar or identical to the example processor system 1110 may be used to implement the XDCP subscription proxy 510, the subscription request processor 705, the push initiator 720 and the mapper 735.

As shown in FIG. 11, the processor system 1110 includes a processor 1112 that is coupled to an interconnection bus 1114. The processor 1112 may be any suitable processor, processing unit, or microprocessor. Although not shown in FIG. 11, the system 1110 may be a multi-processor system and, thus, may include one or more additional processors that are identical or similar to the processor 1112 and that are communicatively coupled to the interconnection bus 1114 The processor 1112 may execute, among other things, machine readable instructions to implement the processes represented in FIGS. 9-10.

The processor 1112 of FIG. 11 is coupled to a chipset 1118, which includes a memory controller 1120 and an input/output (I/O) controller 1122. A chipset provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1125.

In general, the system memory 1124 may include any desired type of volatile and/or non-volatile memory such as, for example, static random access memory (SRAM), dynamic random access memory (DRAM), flash memory, read-only memory (ROM), etc. The mass storage memory 1125 may include any desired type of mass storage device including hard disk drives, optical drives, tape storage devices, etc.

The I/O controller 1122 performs functions that enable the processor 1112 to communicate with peripheral input/output (I/O) devices 1126 and 1128 and a network interface 1130 via an I/O bus 1132. The I/O devices 1126 and 1128 may be any desired type of I/O device such as, for example, a keyboard, a video display or monitor, a mouse, etc. The network interface 1130 may be, for example, an Ethernet device, an asynchronous transfer mode (ATM) device, an 802.11 device, a digital subscriber line (DSL) modem, a cable modem, a cellular modem, etc. that enables the processor system 1110 to communicate with another processor system.

While the memory controller 1120 and the I/O controller 1122 are depicted in FIG. 11 as separate functional blocks within the chipset 1118, the functions performed by these blocks may be integrated within a single semiconductor circuit or may be implemented using two or more separate integrated circuits.

As an alternative to implementing the methods and/or apparatus described herein in a system such as the device of FIG. 11, the methods and or apparatus described herein may be embedded in a structure such as a processor and/or an ASIC (application specific integrated circuit).

From the foregoing, example methods and apparatus to implement non-SIP based document subscription and change notification functionality in an XDM system are disclosed. As described above, an example technique to subscribe for notifications of changes in XML documents managed by an XDM server involves an XDM client sending an XDCP SUBSCRIBE command containing the XCAP URI(s) of the document(s) of interest and the duration of the subscription. The XDCP SUBSCRIBE command can also contain an OMNA registered application ID specifying which of one or more XDM clients on a target device are subscribing for changes of the document(s). Additionally or alternatively, the XDCP SUBSCRIBE command can contain an indication of a level of user interaction to be employed or specified for processing notifications. Additionally or alternatively, the XDCP SUBSCRIBE command can contain an indication of whether the XDM client prefers that the document changes (e.g., in the form of the xcap-diff mime type) are included in the notification (“push”), or that the document changes are stored on the server and only the URL pointing to changes are included in the notification (“pull”), or that just the XCAP URL of the changed document is included in the notification (“none”).

Furthermore, in such an example technique, an intermediate device (such as an XDCP subscription proxy, an appropriately adapted existing subscription proxy, etc.) uses the XDCP SUBSCRIBE command received from the XDM client to create a corresponding SIP SUBSCRIBE request to send to the XDM server to subscribe to changes of specified documents on behalf of the XDM client. The intermediate device also establishes mappings between the SIP subscription and the non-SIP XDM client identified by its tel-URI, the mapping containing information from the XDCP SUBSCRIBE command.

As described above, an example technique to terminate (or, equivalently, unsubscribe to) an existing subscription for notifications of changes in XML documents managed by an XDM server involves an XDM client sending an XDCP SUBSCRIBE command containing the XCAP URI(s) of the document(s) of interest and the duration of the subscription set to zero (0) seconds.

As described above, an example technique to notify an XDM client of changes in an XDM document involves receiving a SIP notification, creating a related PUSH NOTIFICATION message and sending it to the subscribed XDM client. The PUSH NOTIFICATION message can contain a header including an OMNA registered application ID specifying which of one or more XDM clients on a target device is to be notified, with the OMNA registered application ID being stored in a subscription mapping maintained by an intermediate device (such as an XDCP subscription proxy, an appropriately adapted existing subscription proxy, etc.). Additionally or alternatively, the PUSH NOTIFICATION message can contain an indication of a level of user interaction employed or specified for processing notifications, with the possible levels of user interaction encoded as values of the “action” attribute of the “indication” element of the “Service Indication” type of the OMA NOTIFICATION message, and with the level of user interaction being stored in the subscription mapping maintained by the intermediate device. Additionally or alternatively, the PUSH NOTIFICATION message can contain the document changes in the body of the message if the subscription mapping contains a “push” indication. Additionally or alternatively, the intermediate device can store the document changes (in the form of the xcap-diff mime type) and the PUSH NOTIFICATION message can contain only the XCAP URL pointing to the stored changes so the XDM client can retrieve them at later time if the subscription mapping contains a “pull” indication. Additionally or alternatively, the PUSH NOTIFICATION message can contain only the XCAP URL of the changed document if the subscription mapping contains a “none” indication.

Although certain methods, apparatus, and articles of manufacture have been described herein, the scope of the appended claims is not limited thereto. To the contrary, this disclosure covers all methods, apparatus, and articles of manufacture fairly falling within the scope of the appended claims either literally or under the doctrine of equivalents.

1. A method performed at a subscription proxy to notify a principal of a change to an extensible markup language (XML) document, the method comprising:
extracting information from an XML document command protocol (XDCP) request received from an XML document management client (XDMC) used by the principal;
mapping at least some of the information which was extracted to one or more corresponding parameters of a session initiation protocol (SIP) SUBSCRIBE request; and
sending the SIP SUBSCRIBE request to an XML document management server (XDMS) to generate a subscription to notifications regarding changes to the XML document, the XML document being managed by the XDMS.

2. A method as defined in claim 1 wherein the information includes a uniform resource identifier (URI) identifying the XML document or a list identifying a plurality of XML documents including the XML document.

3. A method as defined in claim 1 wherein the information includes a duration, and wherein mapping the information causes an expires header of the SIP SUBSCRIBE request to be set to the duration.

4. A method as defined in claim 1 wherein the information includes a URI to which the notifications are to be sent.

5. A method as defined in claim 1 wherein the information includes an application identifier to identify a client application acting as the XDMC.

6. A method as defined in claim 1 further comprising:
storing the information which was extracted from the XDCP request; and
using at least some of the stored information to route change notifications regarding the XML document to the XDMC.

7. A method as defined in claim 1 further comprising:
receiving a SIP NOTIFY message, the SIP NOTIFY message indicating a change to the XML document; and
sending a push message to forward a notification to the XDMC regarding the change, the push message being at least partially based on the information which was extracted from the XDCP request.

8. A method as defined in claim 7 wherein the information includes a user interaction level that is set to a value to indicate a level of user interaction required for processing notifications, and the push message includes an attribute set to the value of the user interaction level.

9. A method as defined in claim 8 wherein the notification forwarded by the push message is to be processed by the XDMC without user interaction when the value of the user interaction level is set to a first value, and the notification forwarded by the push message is to be processed by the XDMC with user interaction when the value of the user interaction level is set to a second value.

10. A method as defined in claim 7 wherein the information includes a preferred notification type, and the push message is to include at least one of:
a listing of one or more changes that were made to the XML document, when the preferred notification type is set to a first value;
a URI pointing to a difference document comprising the one or more changes that were made to the XML document, when the preferred notification type is set to a second value; and
an identifier pointing to the XML document that was changed, when the preferred notification type is set to a third value.

11. A method as defined in claim 1 wherein the XDMC is one of a trusted XDMC or an untrusted XDMC.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A method performed at a subscription proxy to notify a principal of a change to an extensible markup language (XML) document, the method comprising:
receiving a session initiation protocol (SIP) NOTIFY message indicating a change to an XML document; and
sending, to an XML document management client (XDMC) used by the principal, a push message to forward a notification regarding the change, the push message being at least partially based on first information extracted from the SIP NOTIFY message and stored second information which was previously extracted from an XML document command protocol (XDCP) request previously received from the XDMC for initiating a subscription to notifications regarding changes to the XML document.

25. A method as defined in claim 24 wherein the stored second information includes a user interaction level that is set to a value to indicate a level of user interaction required for processing notifications, and the push message includes an attribute set to the value of the user interaction level.

26. A method as defined in claim 25 wherein the notification forwarded by the push message is to be processed by the XDMC without user interaction when the value of the user interaction level is set to a first value, and the notification forwarded by the push message is to be processed by the XDMC with user interaction when the value of the user interaction level is set to a second value.

27. A method as defined in claim 24 wherein the stored second information includes a preferred notification type, and the push message is to include at least one of:
a listing of one or more changes that were made to the XML document, when the preferred notification type is set to a first value;
a URI pointing to a difference document comprising the one or more changes that were made to the XML document, when the preferred notification type is set to a second value; and
an identifier pointing to the XML document that was changed, when the preferred notification type is set to a third value.

28. A method as defined in claim 27 wherein the difference document is included in the SIP NOTIFY message.

29. A method as defined in claim 24 wherein the push message is sent to a push proxy gateway in communication with the XDMC.

30. A method as defined in claim 24 wherein the XDMC is one of a trusted XDMC or an untrusted XDMC.

31. (canceled)

32. (canceled)

33. (canceled)

34. (canceled)

35. (canceled)

36. (canceled)

37. (canceled)

38. (canceled)

39. A method performed at an extensible markup language (XML) document management client (XDMC) to receive notifications of changes to an XML document, the method comprising:
sending an XML document command protocol (XDCP) request to a subscription proxy to generate a subscription to notifications regarding changes to the XML document, the XML document being managed by an XML document management server (XDMS) communicatively coupled with the subscription proxy; and
receiving a notification, based on the subscription, of a change to the XML document from a push proxy gateway in communication with the subscription proxy.

40. A method as defined in claim 39 wherein the XDCP request includes a uniform resource identifier (URI) identifying the XML document or a list identifying a plurality of XML documents including the XML document.

41. A method as defined in claim 39 wherein the XDCP request includes a subscription duration.

42. A method as defined in claim 39 wherein the XDCP request includes a URI to which the notification is to be sent.

43. A method as defined in claim 39 wherein the XDCP request includes an application identifier to identify a client application acting as the XDMC.

44. A method as defined in claim 39 wherein the XDCP request includes a user interaction level that is set to a value to indicate a level of user interaction required for processing the notification, and the method further comprises:
processing the notification without user interaction when the value of the user interaction level is set to a first value; and
processing the notification with user interaction when the value of the user interaction level is set to a second value.

45. A method as defined in claim 39 wherein the XDCP request includes a preferred notification type, and the notification is to include at least one of:
a listing of one or more changes that were made to the XML document, when the preferred notification type is set to a first value;
a URI pointing to a difference document comprising the one or more changes that were made to the XML document, when the preferred notification type is set to a second value; and
an identifier pointing to the XML document that was changed, when the preferred notification type is set to a third value.

46. A method as defined in claim 39 wherein the XDMC is one of a trusted XDMC or an untrusted XDMC.

47. (canceled)

48. (canceled)

49. (canceled)

50. (canceled)

51. (canceled)

52. (canceled)

53. (canceled)

54. (canceled)

55. (canceled)
